(19) United States
(12) Patent Application Publication
(10) Pub. No.: US 2014/0233800 A1
(43) Pub. Date: Aug. 21, 2014

(54) METHOD OF TRACKING OBJECT AND ELECTRONIC DEVICE SUPPORTING THE SAME

(71) Applicant: Samsung Electronics Co., Ltd., Suwon-si (KR)

(72) Inventors: Gennadiy KIS, Kyiv (UA); Fedir ZUBACH, Kyiv (UA); Oleksiy PANFILOV, Kiev (UA); Kyusung CHO, Suwon-si (KR); Ikhwan CHO, Suwon-si (KR)

(73) Assignee: Samsung Electronics Co., Ltd., Suwon-si (KR)

(21) Appl. No.: 14/180,989

(22) Filed: Feb. 14, 2014

Related U.S. Application Data
(60) Provisional application No. 61/765,404, filed on Feb. 15, 2013.

(30) Foreign Application Priority Data
Jan. 28, 2014 (KR) 10-2014-0010284

(51) Int. Cl. G06T 7/00

(52) U.S. Cl. CPC G06T 7/0044
USPC 382/103

(57) ABSTRACT

A method of tracking an object and an electronic device supporting the same are provided. The method includes predicting a movement of a tracked object, comparing features of current image information based on predicted information with features of each of key frames, selecting a particular key frame from the key frames according to a result of the comparison, and estimating a pose by correcting the movement of the object in the current image information based on the selected key frame, wherein the comparing of the features comprises defining a location value of the feature by relation with neighboring features.

### CROSS-REFERENCE TO RELATED APPLICATION(S)

This application claims the benefit under 35 U.S.C. §119(e) of a U.S. Provisional application filed on Feb. 15, 2013 in the U.S. Patent and Trademark Office and assigned Ser. No. 61/765,404, and under 35 U.S.C. §119(a) of a Korean patent application filed on Jan. 28, 2014 in the Korean Intellectual Property Office and assigned Serial number 10-2014-0010284, the entire disclosure of each of which is hereby incorporated by reference.

### TECHNICAL FIELD

The present disclosure relates to image processing. More particularly, the present disclosure relates to a function of tracking an object.

### BACKGROUND

With advances in related technology, a terminal is now able to support and operate various user functions. For example, a terminal now supports an image collecting function, which has become an important function in the terminal. Accordingly, in relation to the image collecting function, research on practical use and extensibility of the various user functions has been actively progressed. However, there exists a need for an apparatus and method of providing an improved object tracking function.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an improved object tracking function.

In accordance with an aspect of the present disclosure, a method of tracking an object is provided. The method includes predicting a movement of a tracked object, comparing features of current image information based on predicted information with features of each of key frames, selecting a particular key frame from the key frames according to a result of the comparison, and estimating a pose by correcting the movement of the object in the current image information based on the selected key frame, wherein the comparing of the features comprises defining a location value of the feature by relation with neighboring features.

In accordance with another aspect of the present disclosure, a method of operating an electronic device is provided. The method includes tracking a first object in a plurality of images by using the electronic device, wherein the tracking of the first object including determining whether the already tracked first object exists in a first image, as a result of the determining of whether the already tracked first object exists, when the first object exists, selecting one of a plurality of pre-stored image data sets based on at least a part of one or more features of the first object, and when the first object does not exist, selecting one of the plurality of pre-stored image data sets based on a part or all of the first image.

In accordance with another aspect of the present disclosure, an apparatus for supporting object tracking is provided. The apparatus includes an object tracking module configured to, when an object being tracked in previous image information does not exist in current image information, detect the tracked object of the current image information by using previously registered key frames, and an input control module configured to provide the current image information to the object tracking module.

In accordance with another aspect of the present disclosure, an apparatus for supporting object tracking is provided. The apparatus includes an object tracking module configured to detect features of pre-defined key frames and features of current image information and process key frame set registration of the current image information according to a result of comparison between the features of each of the key frames and the features of the current image information and an input control module configured to provide the current image information to the object tracking module.

According to the present disclosure as described above, an improved object tracking function can be supported.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram schematically illustrating an object tracking supporting device that supports an object tracking function according to an embodiment of the present disclosure;

FIG. 2 is a block diagram illustrating a configuration of FIG. 1 in more detail according to an embodiment of the present disclosure;

FIG. 3 is a flowchart illustrating an object tracking method according to an embodiment of the present disclosure;

FIG. 4 is a view describing a feature matching operation according to an embodiment of the present disclosure;

FIG. 5 is a view describing a chain type Binary Robust Independent Elementary Features (BRIEF) descriptor calculation according to an embodiment of the present disclosure;

FIG. 6 is a view describing descriptor patch sizes for the feature of the key frame according to an embodiment of the present disclosure;

FIG. 7 is a flowchart describing a key frame selection operation according to an embodiment of the present disclosure;

FIG. 8 illustrates an example of a key frame selection according to an embodiment of the present disclosure;

FIG. 9 is a flowchart illustrating a key frame set control operation according to an embodiment of the present disclosure;

FIG. 10 is a flowchart describing a relocalization operation according to an embodiment of the present disclosure;

FIG. 11 is a view schematically illustrating a configuration of a system supporting an object tracking function according to an embodiment of the present disclosure;

FIG. 12 illustrates an example of a block diagram of components of FIG. 11 according to an embodiment of the present disclosure;

FIG. 13 schematically illustrates a configuration of an electronic device according to an embodiment of the present disclosure; and

FIG. 14 illustrates a configuration of a platform according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, a technology which is well known in the art to which the present disclosure belongs and has no direct relation to the present disclosure will be omitted. Further, a detailed description of structural elements which have substantially identical configurations and functions will be omitted. For the same reason, in the accompanying drawings, some structural elements are exaggeratedly or schematically shown, or omitted, and each structural element may not be wholly shown in an actual size. Therefore, the present disclosure is not limited by a relative size or distance indicated in the accompanying drawings.

An object tracking supporting device according to the present disclosure described below may recognize a particular object from among elements included in an acquired image. Further, an object tracking supporting device according to the present disclosure supports smoother tracking of the recognized object. An object tracking supporting device may be applied to various image processing technologies. The following description will be made based on a process in which the object tracking supporting device supports an Augmented Reality (AR) function. Accordingly, the object tracking supporting device may be at least a part of an AR processing device.

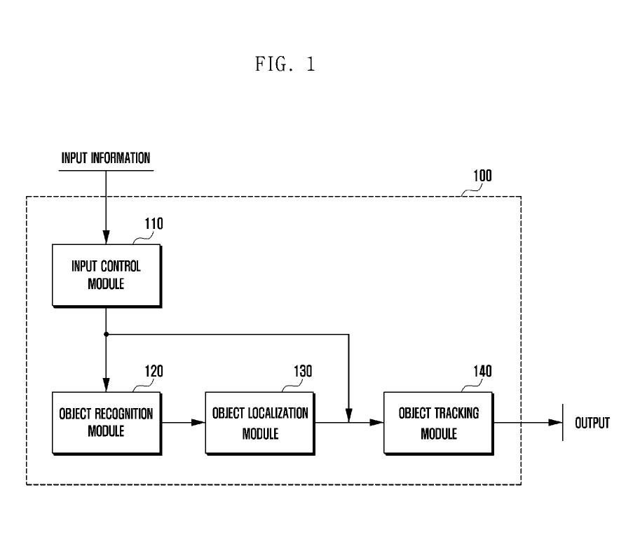

FIG. 1 is a block diagram schematically illustrating an object tracking supporting device that supports an object tracking function according to an embodiment of the present disclosure.

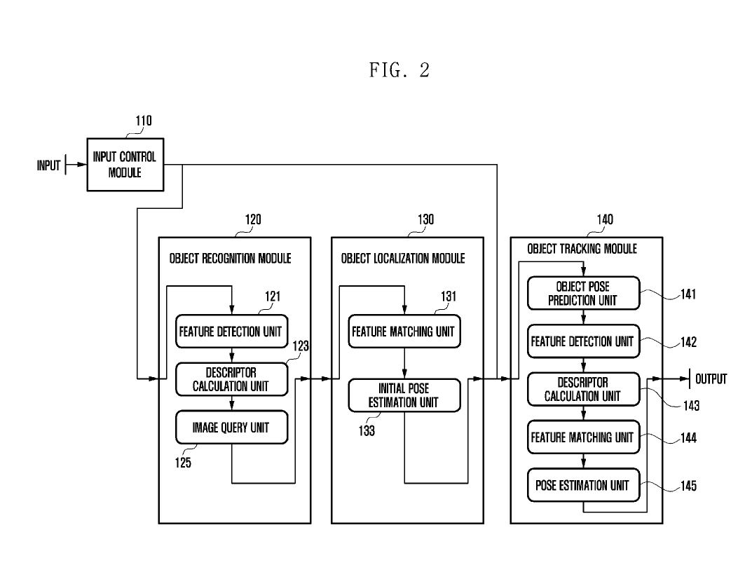

FIG. 2 is a block diagram illustrating a configuration of FIG. 1 in more detail according to an embodiment of the present disclosure.

Referring to FIGS. 1 and 2, an object tracking supporting device 100 may include an input control module 110, an object recognition module 120, an object localization module 130, and an object tracking module 140.

The object tracking supporting device 100 may perform image processing of image information among acquired input information. In such a process, the object tracking supporting device 100 may support a function of tracking an object included in the image information. For example, the object tracking supporting device 100 may support a data operation for efficiently tracking the object, such as a key frame operation including a key frame reference and a key frame update in supporting the object tracking function. The key frame operation may include key frame definition and comparison operations.

The key frame definition operation may define image information including similar features to be compared with the image information including objects which are being currently tracked or including objects including the features as the key frame. The key frame comparison operation compares currently collected image information with at least one key frame, searches for a most similar key frame, and supports processing of tracking objects of current image information based on the found key frame. During the feature definition process, the object tracking supporting device 100 may apply a chain type pyramid Binary Robust Independent Elementary Features (BRIEF) descriptor scheme. Further, the object tracking supporting device 100 may control a key frame set update. In addition, the object tracking supporting device 100 may support processing of image information in which the object tracking using the key frame is failed. Accordingly, the object tracking supporting device 100 may process tracking of actual movements of the objects included in the image through a more simplified calculation. Further, the object tracking supporting device 100 may more accurately and quickly apply AR contents according to the movements of the actual objects.

The input control module 110 may classify input information provided to the object tracking supporting device 100. Further, the input control module 110 may determine a transfer route of the input information according to a function performance state of the current object tracking supporting device 100. For example, the input control module 110 may provide corresponding image information to the object recognition module 120 when initial image information is acquired. The image information may be acquired through an image sensor connected to the object tracking supporting device 100 or an image sensor arranged in a terminal including the object tracking supporting device 100.

The input control module 110 may directly transmit the image information to the object tracking module 140 when an image recognition process by the object recognition module 120 and an object distinguishing process by the object localization module 130 are completed. Alternatively, the input control module 110 may simultaneously transmit the image information to the object recognition module 120 and the object tracking module 140. Accordingly, the recognition processing of the image information and the object tracking processing may be performed in parallel.

The input control module 110 may control not to provide the image information to the object recognition module 120 while the object tracking function is being performed. Further, the input control module 110 may support such that the image information is provided to the object recognition module 120 again when it fails in tracking the object. In addition, the input control module 110 may provide different input information, for example, audio information, sensor information or the like, to the object tracking module 140 when the AR contents are applied to the objects which are being tracked.

When the object recognition module 120 receives the image information from the input control module 110, the object recognition module 120 may perform a recognition process of the image information. The object recognition module 120 may include a feature detection unit 121, a descriptor calculation unit 123, and an image query unit 125 as illustrated in FIG. 2.

The feature detection unit 121 may extract points noticeable against surroundings as features through a filtering process. At this time, the feature detection unit 121 may detect features in various aspects by various filtering information to be applied to the object tracking supporting device 100. For example, the feature detection unit 121 may performed a discretization process on the image information. Further, the feature detection unit 121 may apply a frequency analysis or a particular algorithm to discretized information to make certain features remain.

The descriptor calculation unit 123 may calculate a descriptor based on a result of the feature detection. The descriptor may be information defining a unique characteristic of at least some areas of the corresponding image information calculated based on the detected features. Such a descriptor may be defined by at least one of positions of the features, an arrangement form of the features and the unique characteristic of the features for each portion in the image information. For example, the descriptor may be a value obtained by simplifying a unique characteristic of a point of the image information. Accordingly, at least one descriptor may be extracted from one piece of the image information.

The image query unit 125 may compare the descriptor with reference data through an image query process when the descriptor calculation is completed. For example, the image query unit 125 may identify whether there are reference data having descriptors equal to the calculated descriptors or within a threshold error range from the calculated descriptors. The reference data may be provided from an internal storage unit prepared for an operation of the object tracking supporting device 100. Alternatively, the reference data may be provided from an external storage device, for example, a separate server device or the like, for an operation of the object tracking supporting device 100. The reference data may be image information on a particular image which is previously stored or stored just before currently processed image information is acquired.

For example, in face recognition, an external reference face database is required to recognize authorized faces, and a difference in different faces may be identified. Meanwhile, in general Quick Response (QR) code recognition, a dramatic update of information is not performed. Accordingly, only a specific regulation for the QR code recognition of the database is required, so that the QR code uses the internal reference data. The object recognition module 120 may simplify a calculation in the image recognition process by using the reference data. Furthermore, the object recognition module 120 may identify a target object by using the reference data.

The object localization module 130 may distinguish various objects included in the image information. Further, the object localization module 130 may provide object related information including at least one of matching information and initial pose (e.g., angle) information to the object tracking module 140 when the object tracking supporting device 100 activates the object tracking function. The object localization module 130 may include a feature matching unit 131 and an initial pose estimation unit 133 as illustrated in FIG. 2.

The feature matching unit 131 may extract features of distinguished objects from the image information. Further, the feature matching unit 131 may match features of particular objects with objects of the reference data. At this time, the feature matching unit 131 may newly update the matching information when there is no matching information on the features.

The initial pose estimation unit 133 may estimate an initial pose of at least one object included in the image information when the feature matching of the object is completed.

The object tracking module 140 receives the initial pose estimation of recognized target objects from the initial pose estimation unit 133 of the object localization module 130. Further, the object tracking module 140 may continue tracking the object through a continuous pose calculation of the target object. The object tracking module 140 may have a basic output of the recognition information and the object distinguishing information included in the object pose. For example, the object tracking module 140 may proceed to track objects by using key frames. At this time, the object tracking module 140 may support key frame selection, key frame management, and key frame operation when it fails in tracking the object. As illustrated in FIG. 2, the object tracking module 140 may include an object pose prediction unit 141, a feature detection unit 142, a descriptor calculation unit 143, a feature matching unit 144 and a pose estimation unit 145.

The object pose prediction unit 141 may predict a pose of at least one object included in image information. The object pose prediction unit 141 may receive an initial pose estimation value of at least one object included in the image information from the object localization module 130. Accordingly, the object pose prediction unit 141 may predict the pose of the object according to movements of objects included in the image information, based on the initial pose estimation value of the objects. For example, the object pose prediction unit 141 may predict in which direction, position, and/or pose at least one object included in the image information moves, based on the initial pose estimation value.

For example, the object pose prediction unit 141 compares previously acquired image information with currently acquired image information, so as to calculate a degree of the movement of the whole image information, that is, at least one of a movement distance, a movement direction, and a movement pose. Further, the object pose prediction unit 141 may predict a movement of at least one object included in the image information, based on the calculated movement degree. For example, the object pose prediction unit 141 may perform phase correlation between the previous frame and the current frame such as by applying a Fast Fourier Transform (FFT) algorithm. Further, the object pose prediction unit 141 may predict the movement pose and movement distance of the object by applying various existing algorithms (e.g., Pose from Orthography and Scaling with Iteration (POSIT)). The object pose prediction may be performed in real time.

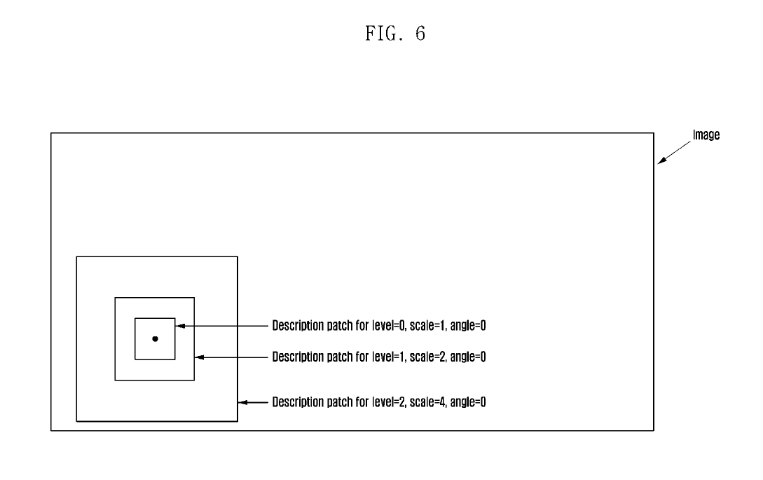

When the prediction of the object movement is completed by the object pose prediction unit 141, the feature detection unit 142 may detect features of the currently acquired image information or features of the object. The same process as a feature detection performed by the object recognition module 120 may be applied to the detection of the features of the image information performed by the feature detection unit 142. Alternatively, the feature detection process performed by the feature detection unit 142 may be simpler than the feature detection process performed by the object recognition module 120. For example, the feature detection unit 142 may extract a smaller number of features in comparison with the feature detection performed by the object recognition module 120, or may extract the features in a narrower area in comparison with the feature detection performed by the object recognition module 120, in order to support the tracking of the movement of the object. For example, the feature detection unit 142 of the object tracking module 140 may detect only features of a particular object within a range area. At this time, the range area may be set in various levels as illustrated below in FIG. 6.

The feature detection unit 142 may select at least one of the previously stored key frames. Further, the feature detection unit 142 may calculate a parameter for matching the current image information and key frames. For example, the feature detection unit 142 may perform integral image processing to record feature location information in the image information. The integral image processing may be processing of defining a location value of each of the features from a reference point of the image information. For example, the image processing may define a location value of a particular feature included in the image information according to each of accumulated areas based on a particular edge point which can be defined as a point, for example, (0, 0) in a (x, y) coordinate. Accordingly, the calculation of the location value of the feature at the particular point may be performed by subtracting a location value of accumulated areas which do not include the corresponding point from the location value of the accumulated areas including the corresponding point. Meanwhile, the feature detection unit 142 may define feature location information in the image information by relation with other features adjacent to the feature.

The descriptor calculation unit 143 may calculate a descriptor based on a result of the feature detection. The descriptor calculation unit 143 may calculate the descriptor based on the features detected by the feature detection unit 142 of the object tracking module 140. The descriptor may be defined by an area or a number of areas arranged on the image information or features of areas included in at least one object. For example, the descriptor calculation unit 143 may use a chain type pyramid BRIEF descriptor (hereinafter referred to as a chain type BRIEF descriptor or a descriptor).

The chain type BRIEF descriptor may rotate (x, y) pairs of features in the image information by the pre-calculated feature pose in order to acquire robustness of the rotation. Further, to provide robustness of blur processing for noise removal and high performance, the chain type BRIEF descriptor may use respective areas around pixels instead of smoothed intensities of the pixels. In addition, the chain type BRIEF descriptor may select a size of one side of a quadrangle in proportion to pre-calculated feature scale and re-calculate a set of (x, y) pairs in accordance with the scale to provide robustness of the scale. The descriptor calculation unit 143 may provide a corresponding result to the feature matching unit 144 when the descriptor calculation is completed.

The feature matching unit 144 may perform the feature matching based on the chain type BRIEF descriptor calculated by the descriptor calculation unit 143. For example, the feature matching unit 144 may search for a descriptor similar to the chain type BRIEF descriptor calculated from the key frame in the current image information and compare the chain type BRIEF descriptor and the found descriptor, so as to perform the matching between the descriptors. When a result of the comparison between the key frame and the current image information is smaller than a threshold value, for example, when the similarity is smaller than a threshold value, the feature matching unit 144 may define the current image information as a new key frame candidate. Further, the feature matching unit 144 may support such that the new key frame candidate is registered in the key frames according to a design scheme. At this time, the feature matching unit 144 may remove a previously registered key frame and register the new key frame candidate as the key frame. Alternatively, the feature matching unit 144 may support such that the new key frame is registered without the removal of the previously registered key frame. Meanwhile, the feature matching unit 144 may perform matching between the current image information and features of at least some areas included in the key frame. Such a case corresponds to a case where the descriptor includes only one feature.

The pose estimation unit 145 may estimate degrees of a pose and a location generated by the object movement in the image information through the descriptor matching between the key frame and the current image information. For example, the pose estimation unit 145 may detect whether the movements of the objects included in the image information match predicted information. Here, the pose estimation unit 145 may identify a changed scale and direction of the object according to the object movement and perform a correction of the object according to the change. The pose estimation unit 145 collects a direction change and a scale change which should be expressed by the actual object movement in a state where the prediction matches the actual object movement.

Further, the pose estimation unit 145 may control to apply contents according to the direction change and the scale change to displaying of augmented reality contents to be applied to the corresponding object. For example, when the scale is reduced according to the movement of the object, the pose estimation unit 145 may change a size of the augmented reality contents to be displayed in accordance with the scale change and display the augmented reality contents of the changed size. Further, when the direction is changed according to the movement of the object, the pose estimation unit 145 may control a direction of the augmented reality contents to be displayed in accordance with the direction change of the corresponding actual object and display the augmented reality contents of the changed direction.

The object tracking module 140 may perform relocalization when failing in tracking the object. Through the relocalization, the object tracking module 140 may rapidly make up for the object tracking failure. When the object which is being tracked is not detected from the current image information, the object tracking module 140 may re-perform the object tracking based on at least one key frame among the key frames used for tracking the object in the corresponding image information. For example, the object tracking module 140 may extract objects from the currently collected image information and compare a descriptor defining features of the extracted objects with descriptors of the objects in the key frames. Further, the object tracking module 140 may select key frames having most similar descriptors and support the re-performance of the object tracking. The object tracking module 140 may compare the similarity between the current image information and the key frame based on a descriptor including at least one feature. As a result, the object tracking module 140 may compare the current image information and at least some features of the key frame and select a key frame which is the most similar to the current image information based on the comparison. Further, the object tracking module 140 may support such that objects included in the selected key frame are tracked for the current image information. To this end, the object tracking module 140 may include a separate component (e.g., a relocalization unit) performing the localization.

The object tracking module 140 may preferentially perform a comparison between a key frame which is used just before the object tracking failure and the current image information. Further, when the similarity between the descriptors is equal to or larger than a threshold value as a result of the corresponding comparison, the object tracking module 140 may support the performance of the object tracking function based on the corresponding key frame without selection and comparison of other key frames. Alternatively, the object tracking module 140 may register previous image information to which the key frame has been applied just before the current image information collection as a new key frame, compare descriptors of the newly registered key frame and the current image information, and make a request for performing the tracking function according to a result of the comparison.

Through such a process, the object tracking module 140 may recover the object tracking failure with a higher probability through the relocalization without re-performance of the object recognition and localization processes when the object tracking has failed. As a result, the object tracking module 140 may support more rapid object tracking performance by reducing time and calculation spent for the object recognition and localization processes through the relocalization.

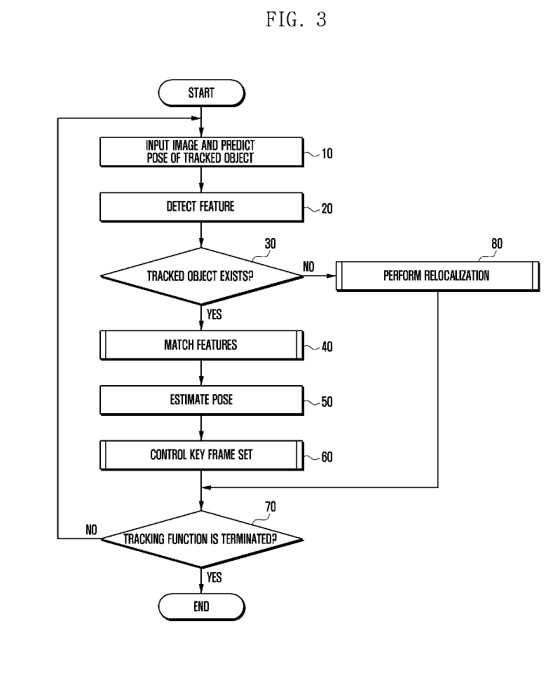

An object tracking function based on the key frame operation will be described in more detail with reference to FIGS. 3 to 10.

FIG. 3 is a flowchart illustrating an object tracking method according to an embodiment of the present disclosure.

Referring to FIG. 3, the object tracking supporting device 100 may receive an image and predict a pose of the tracked object in operation 10. At this time, the object tracking module 140 of the object tracking supporting device 100 may receive initial information on objects included in the image information from the object recognition module 120 and the object localization module 130. The object tracking supporting device 100 may predict poses of the objects included in the image information based on the initial information received from the object recognition module 120 and the object localization module 130. Alternatively, the object tracking supporting device 100 may predict the pose of the object in the current image information based on information related to the object detected from the previous image information. When the prediction of the object pose is completed, the object tracking supporting device 100 detects features of the current image information in operation 20. The feature detection may be performed by the above-described various methods. For example, the feature detection may be a process of applying a particular type of filtering to the current image information. When various subjects are disposed in the image information, at least one feature of respective subjects, for example, various points, such as an edge point, a boundary point, a shadow point, an intersection point of boundaries and the like, may be detected according to the filtering application.

The object tracking supporting device 100 may identify whether the tracked object exists in operation 30. As described above, the object tracking supporting device 100 has already received information indicating that the objects are included in the previous image information or the initial information provided by the object localization module 130 during the object tracking process. Accordingly, the object tracking supporting device 100 may identify whether the tracked object is included in the current image information, or is removed from the current image information and thus is missing in operation 30.

When it is determined that the tracked object exists in operation 30, the object tracking supporting device 100 performs feature matching in operation 40. In order to perform the feature matching, the object tracking supporting device 100 selects at least one key frame and compares the selected key frame with the current image information. During such a process, the object tracking supporting device 100 may compare features of the key frame and the current image information. At this time, the object tracking supporting device 100 may compare one or more descriptors including one or more features to proceed to track the object. Operation 40 will be described in more detail with reference to the drawings described below.

When the feature matching is completed in operation 40, the object tracking supporting device 100 performs pose estimation in operation 50. The object tracking supporting device 100 may apply a view direction difference and a scale difference of objects based on a key frame where objects which are the most similar to the objects detected from the previous image information are disposed while performing the pose estimation. Through the application, the object tracking supporting device 100 may perform a direction and scale correction according to movements of actual objects. In addition, the object tracking supporting device 100 may control additional content application while performing the pose estimation. For example, the object tracking supporting device 100 may create modified, newly selected, or newly generated augmented reality contents by applying values of the view direction difference and the scale difference of the actually moved object to the augmented reality contents. Further, the object tracking supporting device 100 may support such that the modified, newly selected, or newly generated augmented reality contents are output in accordance with the corresponding object.

During the pose estimation process, the object tracking supporting device 100 may support tracking multiple objects. At this time, the object tracking supporting device 100 assumes that all objects stop to improve the performance. Further, the object tracking supporting device 100 may select a visible or core object, for example, an object having a largest size from the image information. The object tracking supporting device 100 switches all matching coordinates of the selected object to a coordinate system by using a relation between the pose of the objects in the previous frame and the pose of other objects. A pose of the selected object may be calculated using all matching points. A change in the pose of previously and currently calculated locations of the object selected based on the assumption may be the same as other objects. Accordingly, poses of other tracked objects can be calculated.

The object tracking supporting device 100 may verify the acquired pose by a number of inliers of the tracked objects. The inliers may be particular object features in the current image information located within a corresponding object area of the key frame. The inliers corresponding to the features within the tracked object may be located within the object area in a state where some objects move in proportion to other objects or background. Meanwhile, when a number of inliers of some objects is smaller than a preset value, the pose calculation of the corresponding object may be calculated again by using matching points. Through the above described pose estimation, the object tracking supporting device 100 may simultaneously track multiple objects when the objects stop or an image sensor itself moves. Further, the object tracking supporting device 100 may guarantee tracking continuity of all tracked objects by using some matching points of the objects.

The object tracking supporting device 100 performs a key frame set control in operation 60. For example, the object tracking supporting device 100 may control whether to register the current image information as a new key frame. Operation 60 may be performed dependently on or independently from operation 40. For example, although it has been illustrated in FIG. 3 that operation 60 is performed after operation 50, operation 60 may be performed just after operation 40 or may be omitted in some cases.

The object tracking supporting device 100 may identify reception of an input event for terminating the tracking function in operation 70. During such an operation, when there is no generation of the input event for terminating the tracking function, the process returns to an operation before operation 10 and the following operations may be re-performed.

Meanwhile, when the tracked object does not exist in the image information in operation 30, the object tracking supporting device 100 may proceed to operation 80 to perform relocalization. While tracking the object in the previous image information, the object tracking supporting device 100 may fail in tracking the object due to a particular reason, for example, in a case where a size of the tracked object is reduced to a size which cannot be recognized, it is displayed as if the tracked object is reduced, or the tracked object is beyond an image acquiring range of the object tracking supporting device 100. Alternatively, even though the object found from the previous image information is included in the current image information, the object tracking supporting device 100 may fail in tracking the object due to an error generated by various environment factors.

In this event, the object tracking supporting device 100 may support the localization process by using the key frames prepared for the object tracking. For example, the object tracking supporting device 100 may compare features of the currently collected image information with at least one key frame and support the object recognition and tracking processes according to the comparison.

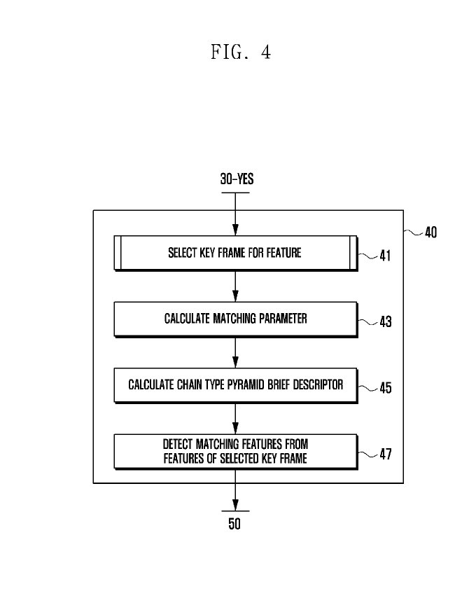

FIG. 4 is a view describing a feature matching operation according to an embodiment of the present disclosure.

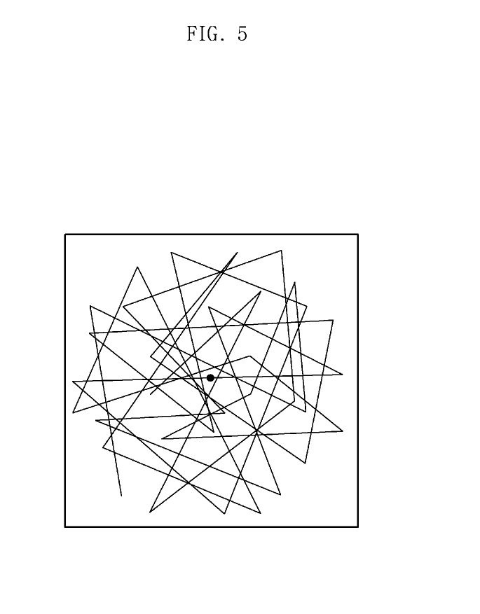

FIG. 5 is a view describing a chain type BRIEF descriptor calculation according to an embodiment of the present disclosure.

FIG. 6 is a view describing descriptor patch sizes for the feature of the key frame according to an embodiment of the present disclosure.

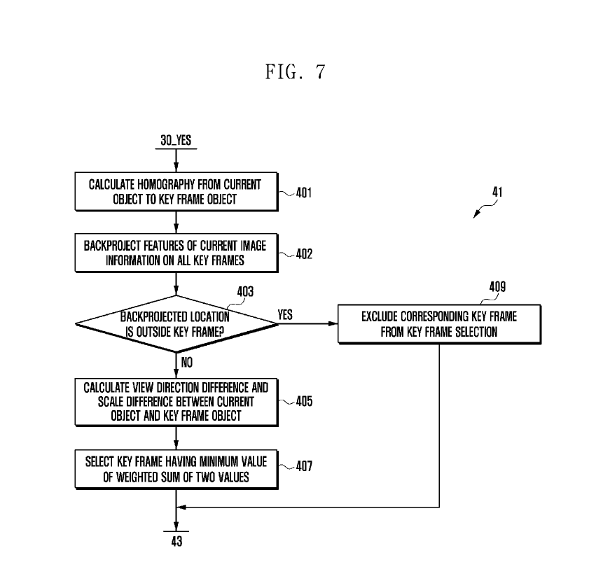

Referring to FIG. 4, when the tracked object exists in the currently acquired image information in operation 30, the object tracking supporting device 100 selects the key frame for the feature in operation 41. At this time, the object tracking supporting device 100 may select an optimal key frame in operation 41 when a plurality of key frames exist. In connection with the key frame selection by the object tracking supporting device 100, a more detailed description will be made with reference to FIG. 7.

When the key frame selection is performed in operation 41, the object tracking supporting device 100 calculates a matching parameter in operation 43. For example, the object tracking supporting device 100 calculates parameter values for features of the key frame to be compared with the features of the current image information. Further, the object tracking supporting device 100 calculates the chain type pyramid BRIEF descriptor based on the calculated matching parameter values in operation 45.

Referring to FIG. 5, the object tracking supporting device 100 performs a filtering process on the key frame to calculate features. Further, the object tracking supporting device 100 calculates parameter values of the calculated features. For example, the object tracking supporting device 100 may calculate a location value of each feature in the image information of the corresponding key frame as described above. At this time, the object tracking supporting device 100 may calculate location information of the features as values accumulated for respective areas. Further, the object tracking supporting device 100 may calculate the chain type BRIEF descriptor for each of the features detected from the key frame.

The object tracking supporting device 100 may store the location value of each of the features as a cell distinguished by a different rotation parameter and a different scale parameter while calculating the chain type BRIEF descriptor. A number of cells may be differently defined according to a level. In the storage process of each cell, the object tracking supporting device 100 generates a lookup table. In order to improve the performance, the object tracking supporting device 100 may replace a set of n(x, y) pairs indicating locations of the features in the image information with adjacent pairs using n+1(x, y) coordinates and (x, y) pairs for the descriptor calculation. For example, the object tracking supporting device 100 may define (x, y) coordinates of the features by using chains connecting the features as illustrated in FIG. 5. In FIG. 5, the features may be located at points where two lines are connected to each other except for a start point and an end point. The chain type BRIEF descriptor having such a structure may distinguish a location value of a particular point by a relation with other features connected through a chain.

Referring to FIG. 6, the descriptor area may be set in several levels when the descriptor for features detected from the key frames and the current image information is configured. For example, as illustrated in FIG. 6, descriptor patches corresponding to the descriptor setting area may include a descriptor patch having level 0, scale 1, and angle 0, a descriptor patch having level 1, scale 2, and angle 0, and a descriptor patch having level 2, scale 4, and angle 0. The sizes and levels of the descriptor may be controlled in proportion to a number of all features and a size of the image information. For example, in a definition of a size of adjacent areas differently made based on a particular feature, a relatively high level or low level may be selected according to a number of features included in the whole image information or the whole key frame. For example, when the number of features detected from the key frame or the current image information is smaller than a threshold number, the relatively high level is selected and thus a descriptor patch having a relatively large area may be applied. Further, when the number of features detected from the key frame or the current image information is larger than or equal to a threshold number, the relatively low level is selected and thus a descriptor patch having a relatively small area may be applied.

Referring again to FIG. 4, the object tracking supporting device 100 detects a matching feature from the features of the selected key frame in operation 47. The object tracking supporting device 100 may find optimal matching of the features in the key frame within a tracking search range of the key frame. The key frames may have a distance for feature location approximation of the key frame. The matching process may be performed in a particular area adjacent to the predicted feature location of the key frame. Further, the feature descriptor of the current image information may be compared with feature descriptors of the key frame in a pre-calculated level.

FIG. 7 is a flowchart describing a key frame selection operation according to an embodiment of the present disclosure.

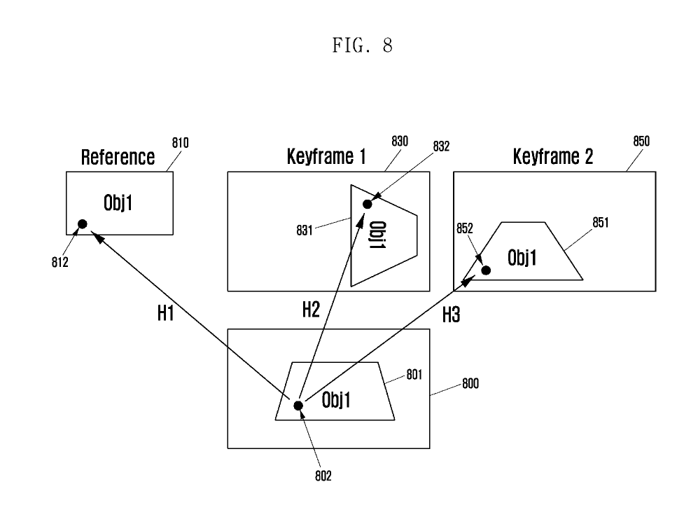

FIG. 8 illustrates an example of a key frame selection according to an embodiment of the present disclosure.

Referring to FIGS. 7 and 8, the object tracking supporting device 100 may proceed to operation 401 when the tracked object exists in the image information in operation 30 to calculate homography (i.e., distorted image correction) from the current object to the key frame object.

When the calculation of homography is completed, the object tracking supporting device 100 may backproject the features of the current image information or the feature descriptor on all key frames in operation 402. Further, the object tracking supporting device 100 may identify whether a backprojected location is outside the key frame in operation 403. When the location is not outside the key frame in operation 403, the object tracking supporting device 100 calculates a view direction difference and a scale difference between the current object and the key frame object in operation 405. For example, the object tracking supporting device 100 may calculate the view direction difference and the scale difference of at least one of the features of the current image and the key frames and the descriptors in a comparison process of at least one of the features and the descriptors.

Referring to FIG. 8, the object tracking supporting device 100 may collect current image information 800 and calculate a feature. Accordingly, the object tracking supporting device 100 may identify that the current image information 800 includes a particular object 801 which is being tracked and a feature or a current descriptor 802 (hereinafter referred to as a descriptor) is located at a point of the corresponding particular object 801. The object tracking supporting device 100 may compare the current descriptor 802 with comparison descriptors 832 and 852 of key objects 831 and 851 included in key frames 830 and 850 and a reference descriptor 812 of a reference object 810. Further, through the comparison between the current descriptor 802 and the comparison and reference descriptors 812, 832, and 852, the object tracking supporting device 100 may identify degrees of a scale difference and a direction difference between the current descriptor 802 and the reference descriptors 812, 832, and 852.

When the view direction difference and the scale difference are calculated, the object tracking supporting device 100 may select a key frame having a minimum value of a weighted sum of the two values in operation 407. Meanwhile, when the location is outside the key frame in operation 403, the process proceeds to operation 409 to exclude the corresponding key frame from the key frame selection.

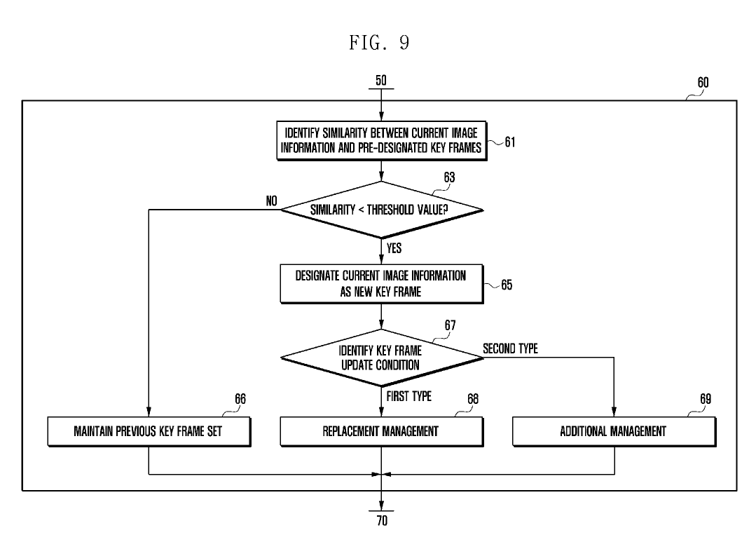

FIG. 9 is a flowchart describing a key frame set control operation according to an embodiment of the present disclosure.

Referring to FIG. 9, after operation 50 of estimating the pose, the object tracking supporting device 100 may identify a similarity between the current image information and pre-stored key frames in operation 61. The similarity may be defined according to a size of the view direction difference and the scale difference between the current image information and the key frames. For example, when a view direction difference and a scale difference between a particular object of the current image information and an object included in the key frame are large, the similarity may have a relatively small value. When the view direction difference and the scale difference between the particular object of the current image information and the object included in the key frame are small, the similarity may have a relatively large value. Here, the object tracking supporting device 100 may quantify the view direction difference and the scale difference and indicate the similarity by a numerical value.

The object tracking supporting device 100 may identify whether the similarity is smaller than a threshold value in operation 63. When the similarity is smaller than the threshold value in operation 63, the object tracking supporting device 100 proceeds to operation 65 to designate the current image information as a new key frame. Further, the object tracking supporting device 100 identifies a key frame update condition in operation 67.

When the designated key frame corresponds to a first type in operation 67, the object tracking supporting device 100 may proceed to operation 68 to perform a key frame replacement management. The object tracking supporting device 100 may remove at least one key frame from the key frames according to a scheme and register the current image information as a new key frame while performing the key frame replacement management. During such a process, the object tracking supporting device 100 may apply at least one of a scheme of removing an oldest key frame, a scheme of removing a key frame which has been least applied to the pose estimation, and a scheme of removing a key frame which has been just stored. The key frame replacement management schemes may be associated with a number of key frames defined by the object tracking supporting device 100. For example, the object tracking supporting device 100 may remove the previously registered key frame to maintain a certain number of key frames when a registration of a new key frame is required.

When the designated key frame corresponds to a second type in operation 67, the object tracking supporting device 100 may proceed to operation 69 to perform a key frame addition management. In the key frame addition management process, the object tracking supporting device 100 may control such that the current image information is registered as a new key frame without removing the already registered key frame.

Meanwhile, when the similarity is larger than or equal to the preset value in operation 63, the object tracking supporting device 100 may proceed to operation 66 to maintain a previous key frame set.

Meanwhile, in the above description, the key frame registration process by the object tracking supporting device 100 is not limited to the similarity comparison. For example, the object tracking supporting device 100 may determine the key frame registration through distributions of inliers and outliers. The outliers may be features of the tracked object in the current image information located outside the object of the key frame. A concentration of a set of the inliers and the outliers calculated by the object tracking supporting device 100 may be used as an estimation value of reliability of the object pose. The object pose reliability may be defined by a degree of matching between a shape of the object in the current image information and a shape of the object in the key frame. In a different expression, the object pose reliability may be calculated by an inlier matching concentration of an entire matching concentration between the object in the current image information and the object in the key frame. When the current image information has reliability having a value larger than or equal to a particular setting value, the corresponding image information may be provided as a key frame candidate. When the current image information has reliability having a value smaller than the particular setting value, the corresponding image information may be registered as a key frame candidate. When a particular object does not exist in key frames or is located far enough from the key frame, the image information having the corresponding object may be registered as the key frame. A value indicating a distance between object poses may include a view angle between frames corresponding to the objects and a homography (distorted image correction) characteristic.

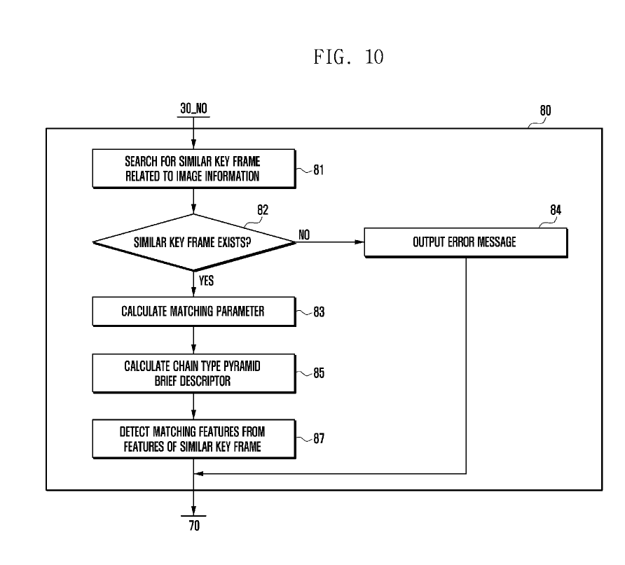

FIG. 10 is a flowchart describing a relocalization operation according to an embodiment of the present disclosure.

Referring to FIG. 10, when the tracked object does not exist in the current image information in operation 30 of FIG. 3, the object tracking supporting device 100 may search for a similar key frame related to the image information in operation 81. In operation 82, the object tracking supporting device 100 identifies whether the similar key frame exists. During such an operation, the object tracking supporting device 100 compares all key frames included in the key frame set and the current image information to identify whether the similar key frame exists. At this time, for a quicker information comparison, the object tracking supporting device 100 may down scale sizes of the key frames and a size of the current image information to a smaller size and control to compare the down scaled images. As described above, a particular tracked object may disappear from the temporarily acquired image information by various environment factors during the object tracking process. Accordingly, when the tracked object does not exist in the current image information, the object tracking supporting device 100 may perform a process of comparing image information collected for a certain time and key frames. Through the process, the object tracking supporting device 100 may support such that a missing object temporarily or by an error is rapidly tracked.

Meanwhile, when a threshold time elapses, the object tracking supporting device 100 proceeds to operation 84 to output an error message and perform operation 70 of FIG. 3.

Meanwhile, when the similar key frame exists in operation 82, the object tracking supporting device 100 selects the corresponding key frame, and calculates a matching parameter based on the selected key frame in operation 83. When the calculation of the matching parameter is completed, the object tracking supporting device 100 calculates the chain type pyramid BRIEF descriptor in operation 85. When the chain type BRIEF descriptor is calculated, the object tracking supporting device 100 detects a matching feature from features of the similar key frame based on the corresponding descriptor in operation 87.

During the similar key frame search process, the object tracking supporting device 100 scales down the size of the current image information to a certain size and blurs the current image information to remove noise, and compares the image information with scaled down and blurred key frames. An image information comparison method may include Sum of Square Distances (SSD), Zero-Mean SSD, and Normalized Cross Correlation (NCC). When there is a key frame similar to the image information, the corresponding key frame may be used for the matching and an object pose may be used for predicting a pose of the object in the current image information. Such a method may provide a better performance improvement in comparison with the localization.

Matching feature coordinates acquired from the key frames may be re-projected on the reference frame by using the pose of the object in the key frames. Such a re-projection function can be performed since the object is a 2D image, and an image plane may be orthogonal to a camera view of the reference frame. Since a plurality of key frames are used to provide the current frame matching and the reference frame preference, accuracy of the matching coordinates increases, and “jump” of the object pose may not be generated when switching is made from one key frame to another key frame. Each key frame may have a tracked object location and also include features which are not included in other objects, such as features related to the background. The object does not move relative to the background. When it is assumed that the background is a plane on which the object is put, the background may be used as an expansion of the objects. Accordingly, the key frames do not need to include features of the objects. Even though the features are not viewed, the last of the features of the object can be tracked. When some objects move in proportion to the background after appearing in a view, a verification may be performed to process a situation.

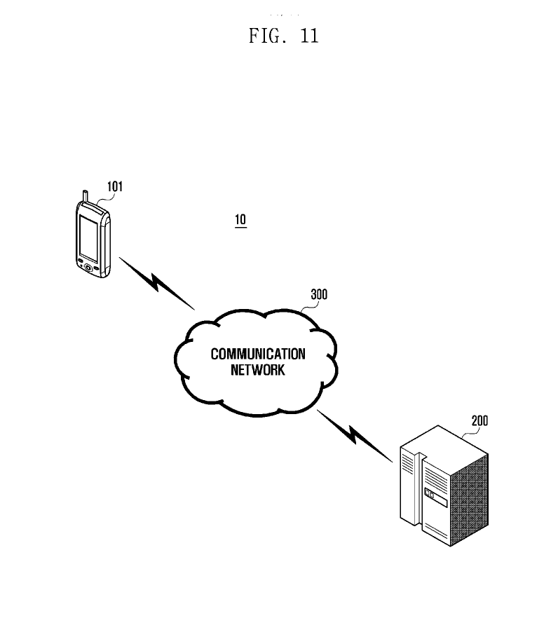

FIG. 11 is a view schematically illustrating a configuration of a system supporting an object tracking function according to an embodiment of the present disclosure.

Referring to FIG. 11, an object processing system 10 may include an electronic device, for example, a user terminal 101, a server device 200 and a communication network 300.

In the object processing system 10 including the above-mentioned configuration, the object tracking module 140 supporting the object tracking function is mounted to the user terminal 101, so as to support the object tracking function. At this time, the object processing system 10 supports a formation of a communication channel between the server device 200 and the user terminal 101 through a communication module of the user terminal 101 and the communication network 300. Accordingly, the object processing system 10 may receive various pieces of information required for a process of supporting the object tracking function through the server device 200. Alternatively, in the object processing system 10 of the present disclosure, the user terminal 101 may receive and store data stored in the server device 200, and support the object tracking function based on the stored data.

The user terminal 101 may access the server device 200 through the communication network 300. Further, the user terminal 101 may provide collected image information to the server device 200. For example, the user terminal 101 may provide the collected image information to the server device 200. The server device 200 may perform the phase correlation for the object tracking based on the received image information and provide a result thereof to the user terminal 101. The user terminal 101 may omit the calculation for the object tracking in the image information and support processing of data for easier object tracking based on values provided by the server device 200. Meanwhile, the user terminal 101 may receive remote reference data and content data provided by the server device 200. Further, the user terminal 101 may perform recognition and localization of the image information by using the remote reference data. In addition, the user terminal 101 may make a control such that the content data is applied to an augmented reality service.

The user terminal 101 may perform relocalization through the server device 200. To this end, the user terminal 101 may provide the key frame set used in the object tracking process and the currently collected image information to the server device 200. Further, the user terminal 101 may receive information on a key frame to be applied to the currently collected image information from the server device 200. The user terminal 101 may track the object by applying the key frame provided by the server device 200 to the current image information.

The communication network 300 may be interposed between the user terminal 101 and the server device 200. Further, the communication network 300 may form a communication channel between the two components. The communication network 300 may be constituted of mobile communication network devices if the user terminal 101 supports a mobile communication function. Furthermore, the communication network 300 may be constituted of devices supporting a corresponding Internet network if the server device 200 connects a communication device through the Internet network. In addition, the communication network 300 further includes a network system for transmitting data between heterogeneous networks. Accordingly, the communication network 300 of the present disclosure is not limited to a scheme, a communication module, or the like for transmitting data between different networks, but should be understood as a device to which various devices and methods for performing data communication between the user terminal 101 and the server system 200 are applied.

The server device 200 may support an access of the user terminal 101. Further, the server device 200 may support the object tracking function and the augmented reality service function according to a request of the user terminal 101. To this end, the server device 200 may store the remote reference data to support the object tracking function. Further, the server device 200 may store the content data to be applied to the augmented reality in order to support the augmented reality service function. The server device 200 may perform at least one of a recognition process, a localization process, and an object tracking process of particular image information according to a request of the user terminal 101. Furthermore, the server device 200 may provide a result of each of the processes according to a request of the user terminal 101. The server device 200 may temporarily or semi-permanently store the key frame applied in the object tracking process. Further, the server device 200 may provide at least a part of the stored key frames to the user terminal 101 according to a request of the user terminal 101. Meanwhile, the server device 200 may perform the calculation of the chain type BRIEF descriptor according to the present disclosure in place of the user terminal 101. To this end, the server device 200 may receive key frame set information and current image information from the user terminal 101. The server device 200 may calculate the descriptor by applying a pre-stored chain type BRIEF descriptor calculation algorithm to the received information. The server device 200 may provide the calculated descriptor to the user terminal 101.

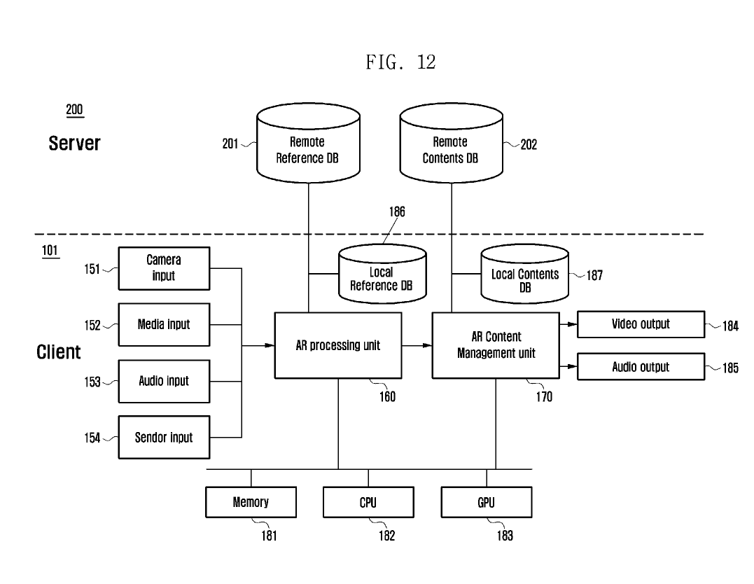

FIG. 12 illustrates an example of a block diagram of components of FIG. 11 according to an embodiment of the present disclosure.

Referring to FIG. 12, the block diagram shows the configuration of the object processing system 10 supporting the AR service which can be applied to at least one of the above mentioned embodiments. The object processing system 10 may include a main unit 160 corresponding to an AR processing unit.

The main unit 160 may receive various input data from input devices, such as a camera input unit 151, a media input unit 152, an audio input unit 153, and a plurality of sensor input units 154. The sensor input units 154 may include inputs from an acceleration sensor, a gyroscope sensor, a magnetic sensor, a temperature sensor, a gravity sensor and the like. The main unit 160 may use a memory 181, a Central Processing Unit (CPU) 182, a Graphic Processing Unit (GPU) 183 and the like for processing the input data. The main unit 160 may use a reference database 201 provided by the server device 200 to identify and recognize targets. The output of the main unit 160 may include identification information and localization information. The reference database 201 may include reference data, a key frame and the like.

The localization information may be used to identify a 2-Dimensional (2D)/3-Dimensional (3D) pose of a target object. The identification information may be used to identify what a target is. An AR contents management unit 170 may use contents from a remote content DB 202 included in the server device 200 or a local content DB 187 and the output of the main unit 160 for combining outputs from a final video output unit 184 and an audio output unit 185. The AR contents management unit 170 may output AR contents to the tracked object.

The object processing system 100 according to the present disclosure described above may be mounted to the main unit 160 in the above-mentioned configuration of the user terminal 101. Further, the object processing system 100 may be mounted to the user terminal 101 while including the main unit 160 and the AR contents management unit 170.

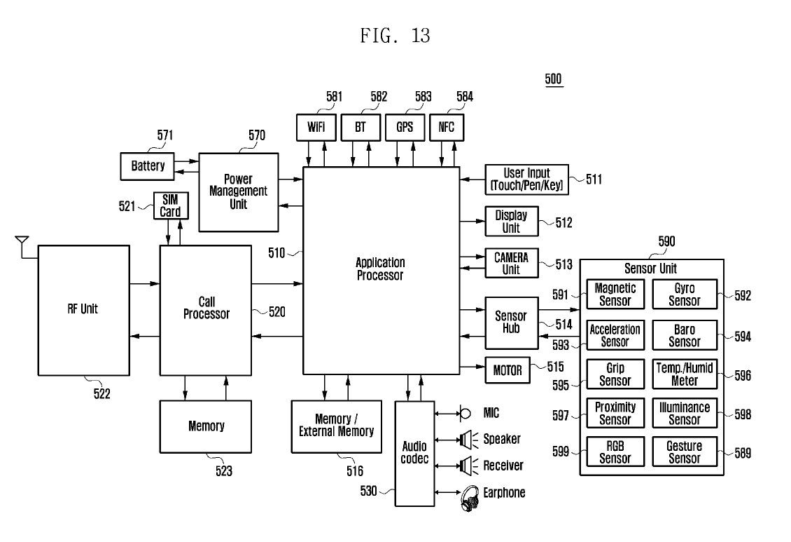

FIG. 13 schematically illustrates a configuration of an electronic device according to an embodiment of the present disclosure. For example, an electronic device 500 illustrated in FIG. 13 may be an example of the electronic device equipped with the above mentioned object tracking module 140.

Referring to FIG. 13, the electronic device 500 may include an application processor 510 and a call processor 520. The call processor 520 may transmit/receive a signal to/from a Radio Frequency (RF) unit 522 and may transmit/receive a signal to/from a memory 523 and a Subscriber Identification Module (SIM) card 521. In addition, the call processor 520 may communicate with the application processor 510, so as to support a function necessary for accessing the RF unit 522, the memory 523 and the SIM card 521 among the functions processed by the application processor 510. The above-mentioned object processing system 100 may be mounted to any one of the application processor 510 and the call processor 520 in the configuration of the electronic device 500. Alternatively, the object tracking supporting device 100 may be provided as a separate hardware device independently from the above mentioned configurations of the electronic device 500, and disposed in a predetermined area of the electronic device 500.

The application processor 510 receives power from a power management unit 571 to which a battery 570 is connected. The application processor 510 may transmit/receive a signal to/from various communication modules other than the RF unit 522, for example, a WiFi module 581, a BlueTooth (BT) module 582, a Global Positioning System (GPS) module 583, a Near Field Communication (NFC) module 584 and support a function performed by each of the modules. The application processor 510 may be connected with a user input unit 511 including a touch input, a pen input, a key input and the like. The application processor 510 may be connected with a display unit 512, a camera unit 513, a motor 515, an audio processor 530, a memory/external memory 516 and the like. The audio processor 530 may be connected with a Microphone (MIC), a speaker, a receiver, an earphone connecting jack and the like. The application processor 510 may be connected with a sensor hub 514. The sensor hub 514 may be connected with a sensor unit 590 including various sensors. The sensor unit 590 may include at least one of a magnetic sensor 591, a gyro sensor 592, an acceleration sensor 593, a barometer 594, a grip sensor 595, a temperature/humidity sensor 596, a proximity sensor 597, an illuminance sensor 598, a Red Green Blue (RGB) sensor 599, and a gesture sensor 589.

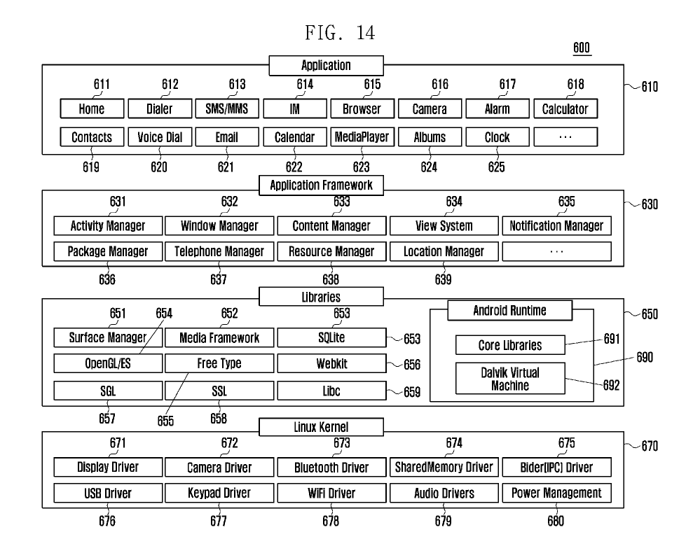

FIG. 14 illustrates a configuration of a platform according to an embodiment of the present disclosure. The object tracking function according to an embodiment of the present disclosure may use at least some components of the following platform or other components may be added as necessary.

Referring to FIG. 14, a platform 600 to which the object tracking function according to the present disclosure is applied may mainly include an application layer 610, an application framework layer 630, a library layer 650, and a kernel layer 670.

The kernel layer 670 may be configured by, for example, a Linux kernel. The kernel layer 670 may include a display driver 671, a camera driver 672, a BlueTooth (BT) driver 673, a shared memory driver 674, a bider driver 675, a Universal Serial Bus (USB) driver 676, a keypad driver 677, a WiFi driver 678, an audio driver 679, and a power management unit 680.

The library layer 650 may include a surface manager 651, a media framework 652, SQLite 653, OpenGL/ES 654, FreeType 655, Webkit 656, SGL 657, SSL 658, and Libc 659. The library layer 650 may include a configuration of Android runtime 690. The Android runtime 690 may include core libraries 691 and Dalvik Virtual Machine 692. The Dalvik Virtual Machine 692 may support a widget function, a function requiring real-time execution, and a function requiring cyclic execution according to a preset schedule, of a terminal supporting the object tracking function.

The application framework layer 630 may include an activity manger 631, a window manager 632, a content manager 633, a view system 634, a notification manager 635, a package manager 636, a telephone manager 637, a resource manager 638, and a location manager 639.

The application layer 610 may include a home application (hereinafter referred to as an app) 611, a dialer app 612, an SMS/MMS app 613, an IM app 614, a browser app 615, a camera app 616, an alarm app 617, a calculator app 618, a content app 619, a voice dial app 620, an email app 621, a calendar app 622, a media player app 623, an album app 624, and a clock app 625. Meanwhile, FIG. 14 illustrates a configuration of the platform of the operating system which is generally most widely used in the electronic device. However, it is apparent to those skilled in the art that the object tracking function according to the present disclosure is not limited to using the above platform but can be implemented using a platform of an operating system in another type.

The above mentioned configurations do not limit a feature or a technical scope of the present disclosure, and merely illustrate examples to which the feature of the present disclosure is applicable. Some configurations of a system or a device shown in FIGS. 10 and 11 may be applicable in order to technically implement the present disclosure. Further, in view of those skilled in the art, the above mentioned configurations may be added to, omitted or modified in various embodiments of the present disclosure. Additionally, other configurations may be added according to a necessity of the embodiment of the present disclosure described above. One or more methods, steps, and algorithms disclosed in the present disclosure may be executed by using one or more configurations described in the above mentioned and implemented embodiments.

On the other hand, the above-mentioned user terminal, electronic device, and the like may further include various and additional modules according to their provided type. For example, in the case that the user terminal, electronic device and the like are communication terminals, they may further include configurations such as a short-range communication module for short-range communication, an interface for a transmission and reception of data by a wired communication scheme or a wireless communication scheme of the user terminal and the electronic device, an Internet communication module for communication with the Internet network to perform the Internet function, a digital broadcasting module for receiving and reproducing digital broadcasting, and the like, which are not described above. Such structural elements may have various modifications which are not listed, according to a convergence trend of a digital device. However, a structural element having a level equal to the above-mentioned structural elements may be further included. Further, in the user terminal, the electronic device and the like of the present disclosure, specific structural elements may be removed from the above-mentioned configuration or substituted with other structural elements according to their provided type. This will be understood by those skilled in the art. Further, the user terminal, the electronic device and the like according to the embodiment of the present disclosure may include, for example, all information and communication devices, multimedia devices and the application devices thereof, such as a Portable Multimedia Player (PMP), a digital broadcasting player, a Personal Digital Assistant (PDA), a music reproduction device, e.g., an MP3 player, a portable gaming terminal, a smart phone, a laptop computer, a note PC, a slate PC, a tap-book computer, a hand-held PC and the like, as well as all mobile communication terminals which are operated based on communication protocols corresponding to various communication systems.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of tracking an object, the method comprising:
predicting a movement of a tracked object;
comparing features of current image information based on predicted information with features of each of key frames;
selecting a particular key frame from the key frames according to a result of the comparison; and
estimating a pose by correcting the movement of the object in the current image information based on the selected key frame,
wherein the comparing of the features comprises defining a location value of the feature by relation with neighboring features.

2. The method of claim 1, wherein the comparing of the features comprises:
calculating a chain type pyramid descriptor connecting the features of the key frame in a chain type;
calculating a chain type pyramid descriptor connecting the features of the image information in a chain type; and
comparing the chain type pyramid descriptor of the key frame and the chain type pyramid descriptor of the image information.

3. The method of claim 1, wherein the selecting of the particular key frame comprises:
backprojecting the features of the current image information on the key frames; and
selecting a key frame having a minimum view direction difference and a minimum scale difference between the backprojected features of the key frames and the features of the current image information.

4. The method of claim 3, wherein the estimating of the pose comprises applying a view direction difference and a scale difference from the selected key frame to multiple objects included in the image information.

5. The method of claim 1, further comprising:
identifying whether the tracked object exists in the current image information; and
when the tracked object does not exist in the current image information, performing relocalization for detecting the object of the current image information based on one or more of the key frames.

6. The method of claim 5, wherein the performing of the relocalization comprises:
calculating a chain type pyramid descriptor connecting the features of the key frame in a chain type in each of the key frames;
calculating a chain type pyramid descriptor connecting the features of the current image information in a chain type;
comparing each of the chain type pyramid descriptors of the key frames and the chain type pyramid descriptor of the current image information to select a most similar key frame; and
estimating a pose by matching features included in the selected key frame with the features of the current image information.

7. The method of claim 5, further comprising outputting an object tracking failure message.

8. The method of claim 1, further comprising processing a key frame set registration of the current image information according to a result of the comparison between the current image information and the key frames,
wherein the processing of the key frame set registration comprises:
comparing similarity between the current image information and the key frames;
when the similarity is smaller than a threshold value, registering the current image information as a new key frame; and
when the similarity is larger than or equal to a threshold value, maintaining a previous key frame set.

9. The method of claim 8, wherein the processing of the key frame set registration comprises:
removing at least one of previously registered key frames and registering the current image information as a new key frame; or
maintaining the previously registered key frames and additionally registering the current image information as the new key frame.

10. An apparatus for supporting object tracking, the apparatus comprising:
an object tracking module configured to detect features of pre-defined key frames and features of current image information and to process key frame set registration of the current image information according to a result of comparison between the features of each of the key frames and the features of the current image information; and
an input control module configured to provide the current image information to the object tracking module.

11. The apparatus of claim 10, wherein the object tracking module comprises:
an object pose prediction unit configured to predict a movement of a tracked object to be included in the current image information;
a feature detection unit configured to detect the features of each of the key frames and the features of the current image information;
a descriptor calculation unit configured to calculate a descriptor including the features; and
a feature matching unit configured to compare a descriptor of each of the key frames and a descriptor of the current image information and to process the key frame set registration of the current image information according to a result of the comparison.

12. The apparatus of claim 11, wherein the feature matching unit compares similarity between the current image information and the key frames, registers the current image information as a new key frame when the similarity is smaller than a threshold value, and maintains a previous key frame set when the similarity is larger than or equal to the threshold value.

13. The apparatus of claim 11, wherein the matching unit removes at least one of previously registered key frames and registers the current image information as a new key frame, or maintains the previously registered key frames and additionally registers the current image information as the new key frame.

14. The apparatus of claim 10, wherein the feature detection unit defines location values of the features by relation with neighboring features.

15. A method of operating an electronic device, the method comprising:
tracking a first object in a plurality of images by using the electronic device,
wherein the tracking of the first object comprises:
determining whether the already tracked first object exists in a first image;
as a result of the determining of whether the already tracked first object exists, when the first object exists, selecting one of a plurality of pre-stored image data sets based on at least a part of one or more features of the first object; and
when the first object does not exist, selecting one of the plurality of pre-stored image data sets based on a part or all of the first image.

16. The method of claim 15, wherein the image data sets include a set of key frames.

17. The method of claim 16, wherein one or more of the key frames include information on one or more of a descriptor, a pose, and a distance of one or more objects in the plurality of images.

18. The method of claim 15, wherein the selecting of the one of the plurality of pre-stored image data sets based on at least the part of the one or more features of the first object when the first object exists comprises comparing the one or more features of the first object and one or more features of the first object included in the plurality of pre-stored image data sets.

19. The method of claim 18, wherein the comparing of the one or more features of the first object and the one or more features of the first object included in the plurality of pre-stored image data sets comprises comparing features in the first image and features within the selected one image data.

20. The method of claim 15, further comprising comparing features in the first image and features within the selected one image data after the selecting of the one of the plurality of pre-stored image data sets based on the part or all of the first image when the first object does not exist.
